(19) United States
(12) Patent Application Publication
(10) Pub. No.: US 2012/0013639 A1
(43) Pub. Date: Jan. 19, 2012

(54) Computer for restricted spaces

(76) Inventor: Everett Simons, Arlington, VA (US)

(21) Appl. No.: 12/804,047

(22) Filed: Jul. 13, 2010

(51) Int. Cl. G09G 5/00

(52) U.S. Cl. 345/619

(57) ABSTRACT

A laptop computer has a reflective transparent plate between the keyboard and the screen. Users viewing the keyboard through the plate sees a virtual image of the screen, reflected by the plate. This virtual image may include labels apparently superimposed on the keyboard; the keys themselves may be blank. Hands resting on the keyboard block the user's view of some keys, but do not block the view of the virtual image. This allows any key to be identified without moving the hands out of the way. The application (task) also exists within the virtual image, apparently in a pane just beyond the keyboard. This pane may extend over the keyboard, in lieu of the default virtual image labels for the keys. The task scrolls to maintain the active region of the task pane beyond the keyboard. Pressing control keys causes virtual image labels to indicate the newly enabled key functionality.

### BACKGROUND OF THE INVENTION

1. Field of the Invention

The invention relates to laptop computers.

2. Description of Related Art

A computer keyboard typically includes an array of input keys, usually labeled with either one character, such as a letter, or two characters, such as “:” above “;”. Pressing an input key generates an associated character value. Computer keyboards usually include control keys, such as <Shift>, <Ctrl>, and <Alt>, that can modify the effect of pressing an input key. For example, with a 104-key PC U.S. English QWERTY keyboard, the key that would generate a semicolon (“;”) when pressed by itself would instead generate a colon (“:”) when pressed in conjunction with the <Shift> key. In some applications, pressing a key while holding the <Ctrl> key can activate a shortcut to a function; for example, pressing “C” while holding <Ctrl> may activate the “Copy” function. A computer keyboard usually also has a row of function keys, e.g. F1-F12, associated with various purposes, which may vary among applications.

Virtual reality headsets create a stereoscopic effect by providing separate image sources for the left and right eyes, viewed through two separate optical paths containing lenses. In this context, the term “virtual” means “simulated by computer”. The apparent distance from the user to a virtual object results from manipulating the offset between the two depictions of the object in the two separate image sources to create apparent perspective, and not from the actual focal distance from the user to the image source along the user's line of sight.

Virtual reality headsets use sensors to measure the location of the user's head. When the user's head turns, the computer tracks the motion and changes the image sources accordingly. This creates the visual perception that the virtual world reference positions remained fixed in space; i.e., the illusion of fixed location is created by changing the images in reaction to motion of the user's head.

In contrast, “virtual image” is an optical term for an image where the light appearing to emanate from one point did not actually originate at that point. For example, when an object is reflected in a mirror, the reflection is a type of virtual image. A monitor would thus not be brought within the definition of “virtual image” merely because a computer was generating an image and sending this image to the monitor. The term “virtual image” is used herein only in the optical sense, not in the “computer-generated” sense.

With a heads-up display, the user views the real world through a transparent element, such as a windshield, and also sees the display reflected in the transparent element. This partial reflection is a type of virtual image. Such a virtual image can display data, e.g., vehicle speed.

U.S. patent application Ser. No. 11/586,423, the teachings of which are hereby incorporated by reference, discloses various methods and apparatus for superimposing virtual image labels onto a keyboard. U.S. patent application Ser. No. 12/802,95, the teachings of which are hereby incorporated by reference, also discloses various methods and apparatus for superimposing virtual image labels onto a keyboard.

### BRIEF SUMMARY OF THE INVENTION

One embodiment uses a laptop computer, with a keyboard and a screen, and a partially reflective transparent plate midway between the keyboard and the screen. Rather than looking at the screen directly, a user looking through the plate at the keyboard sees a partial reflection of the screen. The screen may be tilted towards the user, rather than away from the user. This allows the computer to be used in confined spaces, such as airline seats, that would otherwise be too small for convenient use of a conventional laptop computer of similar size.

When a user observes the keyboard by looking through the plate, the user sees both the keyboard and a virtual image of the screen, created by partial reflection in the plate. In some embodiments, this portion of the virtual image contains labels for the keys; these virtual image labels appear to exist on the keys. The physical keys themselves may be blank.

The term “virtual image label” is being used herein to mean a label that is part of an inherently stationary virtual image with a focal distance equal to the actual distance along the user's line of sight to the physical object creating the image, and thus excludes holograms. Two adjacent observers would perceive the same virtual image label to be in the same location, despite the slight angle between their lines of sight. The term “virtual image label” excludes active headsets wherein the optical display reacts to the user's head motion to create the perception that the image has a fixed location. A label is not brought within the definition of “virtual image label” merely because the image containing the label was generated by computer.

When the user's hands are not on the keyboard, the user perceives a keyboard with labeled keys. Because the virtual image containing the key labels is created by a reflection from above the plate, nothing below the plate blocks the user's view of the key labels. Therefore, when the user's hands are operating the keyboard, the hands do not block the reflection, and the virtual image containing the key labels remains visible. Users thus have the visual impression of being able to see the key labels through their own hands. This allows the keys to be identified without requiring users to move their hands out of the way.

In some embodiments, the virtual image labels change in response to user actions; e.g., pressing the control key <Ctrl> causing the various character key labels to display the associated shortcuts, such as the “C” virtual image label changing to “Copy” to indicate the function that would be activated by pressing the combination of <Ctrl> and the “C” key simultaneously, sometimes denoted as “̂C”. The status of each of the control keys can be determined individually. For example, Microsoft Visual Basic 2008™ provides Booleans, such as “My.Computer.Keyboard.AltKeyDown” which indicates the <Alt> control key status, that are independent of character key actuation. In some embodiments, the more frequently used combinations are emphasized. In some embodiments, the least frequently used combinations are omitted. In some embodiments, a compound virtual image label displays both the function and the shortcut, e.g. “Copy (̂C)”, for pedagogical reinforcement.

In some embodiments, the hue of a key's virtual image label changed from red to blue when the key was pressed. This created the visual perception of downwards motion: as the key was pressed down, the virtual image label apparently “on” the key seemed to move down with the key, even though the screen itself was a flat panel display.

In one embodiment, the screen and reflective plate were synchronously articulated to allow the screen and reflective surface to move while keeping the virtual image stationary. This enabled the system to be adjusted, e.g. to accommodate users of different heights, while maintaining alignment of the virtual image labels relative to the associated keys.

### BRIEF DESCRIPTION OF THE SEVERAL VIEWS OF THE DRAWINGS

It is to be understood that both the foregoing general description and the following detailed description are exemplary and explanatory only and are not restrictive of the invention, as claimed. The accompanying drawings, which are incorporated in and constitute a part of this specification, illustrate an embodiment of the invention and together with the description, serve to explain the principles of various aspects of the invention. The term “reflection” shall include partial reflection in a transparent plate. The term “inverted” shall mean a mirror image flipped top-to-bottom; reflection of an inverted image would thus be right-reading.

FIG. 1 illustrates a system where the screen of a laptop computer is reflected in a plate to create virtual image labels at the keys of the laptop computer, while the task at hand runs on a second monitor connected to the laptop computer.

FIG. 2 illustrates a profile view of an embodiment of the present invention; both the task at hand and the virtual image labels appear to the user to be in a common plane, with the virtual image labels apparently on the keys of the keyboard.

In this disclosure, the use of the singular includes the possibility of the plural. The use of the term “with” is not limiting; similarly, the use of the terms “including” and “having”, as well as other forms of these terms such as “has”, are not limiting. The use of “or” means “and/or” unless stated otherwise. The sectional heading used herein are for organizational purposes only, and are not to be construed as limiting the subject matter described. The term “task” will be used to describe the application being run by the user (e.g. word processor, spreadsheet, or game), rather than the mere act of typing and verifying a string of characters.

### DETAILED DESCRIPTION

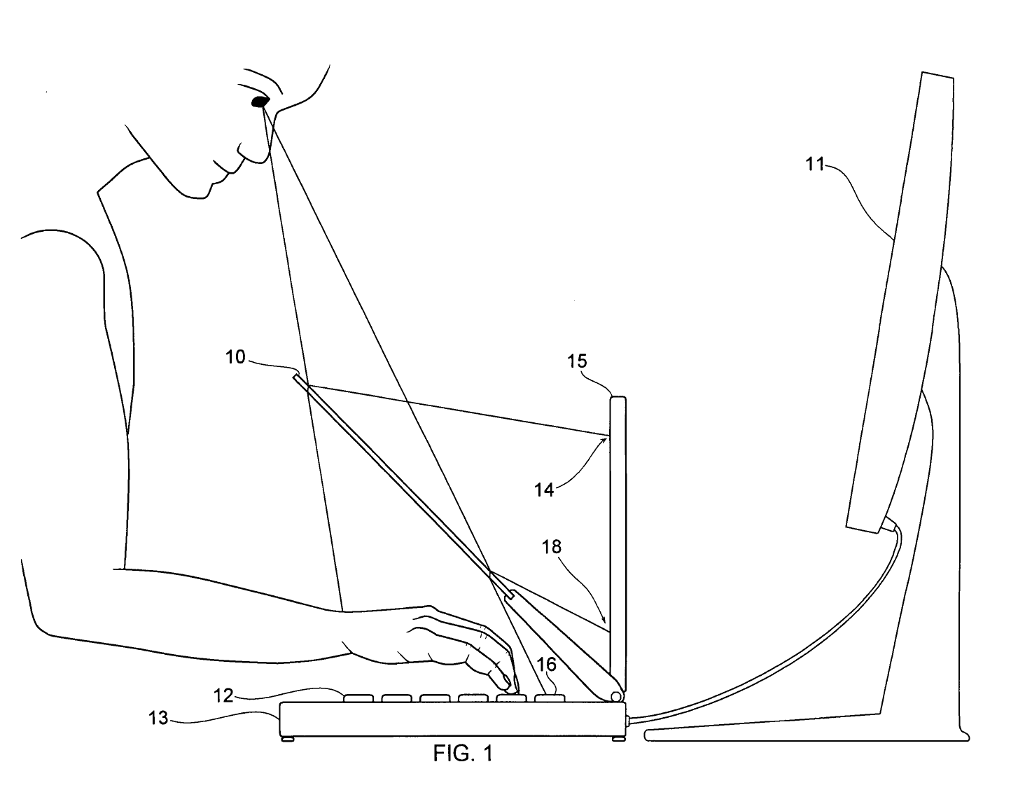

FIG. 1 illustrates a laptop computer with a reflective transparent plate 10 midway between a keyboard 13 and a screen 15. Reflection of an inverted key label at location 18 creates a virtual image label that appears to exist on key 16. The user's view of key 12 is blocked by the hand above, but reflection of an inverted key label at location 14 creates a virtual image label that appears to exist at key 12. Thus, the user's hands do not block any of the virtual image labels of the keys. The task is displayed on a monitor 11.

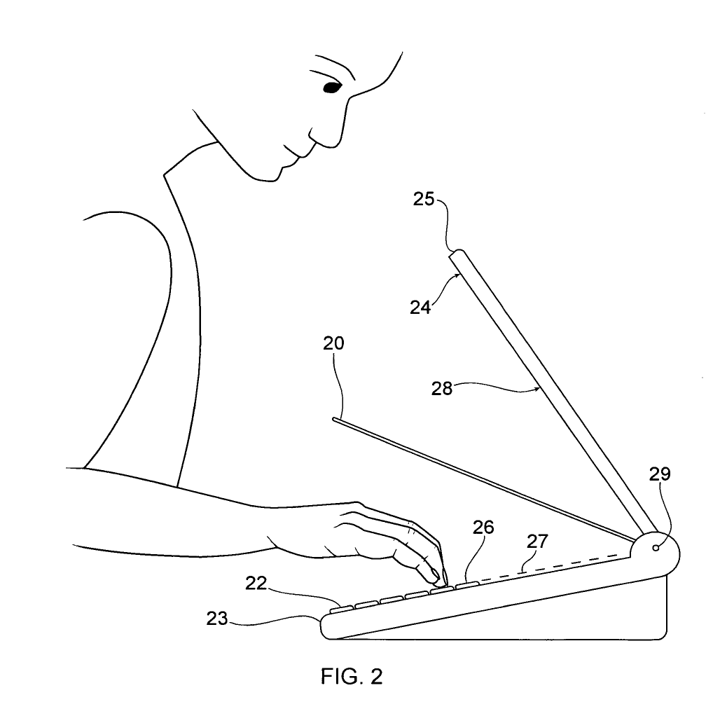

FIG. 2 illustrates an embodiment of the present invention comprising a laptop computer with a keyboard 23 and a screen 25. The user only has a direct view of the edge, not the face, of screen 25 when the screen is adjusted to the angle shown in this figure. The image on the screen is reflected in the plate 20, creating a virtual image that appears to be in the same plane as keys 22 and 26. Reflection of an inverted label at location 28 creates a virtual image label that appears to exist at key 26. The user's view of key 22 is blocked by the hand above, but reflection of an inverted key label at location 24 creates a virtual image label that appears to exist at key 22. Thus, the user's hands do not block any of the virtual image labels of the keys. The task is displayed inverted on the portion of the screen 25 below location 28; the virtual image of the task exists at the area 27 (indicated by a dotted line), which may exist in free space as shown, or on a surface of the laptop computer. The portion of the laptop computer between the key 26 and pivot axis 29 is preferably a non-reflective black or other dark background. The task may also extend over the keys. Plate 20 preferably has a partially reflective surface on the side towards screen 25, an anti-reflective coating on the side towards the keyboard 23, or both.

In this embodiment, screen 25 rotates relative to the keyboard 23 about axis 29, and can pivot by at least one radian. Plate 20 also rotates about axis 29, and bisects the plane of the image surface of screen 25 and the plane of the keys 22 and 26. The operational size of such a system is characterized by the distance, measured along a 30 degree elevation, from the lower edge of the system nearest the user to the back of the screen 25. The operational size determines whether a particular configuration will be practical for use within a confined space such as an airplane seat. The operational size of the embodiment illustrated in FIG. 2 is 30% larger than the height of the display area of the screen. The operational envelope is the range of operational sizes over which a particular embodiment can be adjusted while still allowing the user to view the virtual image. The operational envelope of the embodiment illustrated in FIG. 2 is about 20 to 60% larger than the height of the display area of screen 25. The ratio of the operational size relative to the height of the display area thus ranges from about 1.2 to 1.6, and the preferable operating range is about 1.25 to 1.5. The ratio at the illustrated adjustment point is about 1.3. In contrast, operation of a conventional laptop computer requires over 70% more clearance, and typically uses 100% more clearance, than the height of the display area. The compact nature of this embodiment facilitates use in tight quarters. Since the top of screen 25 tilts towards the user, this system is particularly well-adapted for use in airplanes, where the seat of the passenger in front of the user would interfere with the use of a conventional laptop computer.

The task can be expanded beyond area 27 and extend over key 26 and beyond. Visibility of the task in the area overlapping the keyboard is enhanced by using a generally bright background within the task. The system can automatically scroll the task to position the active portion of the task (typically the insertion point, the cursor, or a drop-down menu) within area 27. The area allocated to the task can expand into the virtual image directly above the keys under normal circumstances, but display virtual image labels of the keys whenever the control keys are pressed. Keeping the active portion of the task within area 27 avoids interference with the virtual image labels.

A system especially adapted for use within aircraft and trains would preferably have electronics using balanced pair transmission lines, for electromagnetic compatibility, and a solid state drive, for robustness. Limiting each user's write-access capability to their own removable storage device, such as a USB flash drive, and/or volatile memory within the system, such as a RAM-based solid state drive, would facilitate sequential sharing of the same system by different users. Travelers could thus bring their own storage device but use the carrier's computer. Restoring the system to its original state each time the power is turned off prevents accidental disclosure of private information or transmission of computer viruses.

In applications where background and foreground colors are selectable, the task may be readily extended to encompass the entire virtual image. Visibility of the task relative to the keyboard may be enhanced by rotating the plane of the virtual image away from the plane of the keyboard 23; when the virtual image appears to be well below the keyboard, the user's eyes readily focus on the task to the exclusion of the keyboard and hands above it. In systems with a synchronous articulation between among the keyboard 23, plate 20, and screen 25, this can be done by disengaging any of these three members from the synchronizing element, e.g., by overcoming a detent. When virtual image labeling of the keyboard is again desired, the system can be resynchronized by reengaging the detent. Alternatively, when the user wishes to forego virtual image labeling of the keys and use the entire virtual image for the task, a sheet (preferably dark) may be placed below the underside of the plate 20, thus blocking any view of the keys. This is particularly beneficial when the task necessarily includes regions that are relatively dark, such as tasks involving photographs.

When one or more control keys are pressed, the resulting changes in functionality of other keys can be indicated by highlighting virtual image labels that were already visible, or by providing a completely new or different virtual image label. For example, in some embodiments, holding the <Shift> key highlighted characters that were already visible, such as “<”, “:”, “{”, “!”, “@”, “#”, etc., but holding the <Ctrl> key caused the virtual image to display completely new function labels, such as “Copy” at the “C” key, “Paste” at the “V” key, etc.

Some embodiments expanded certain virtual image labels while contracting adjacent labels, to accommodate longer descriptions by encroaching slightly over adjacent keys. For example, holding the <Shift> key caused the “Delete” virtual image label to become “Delete/without/placing in/recycle bin” (where each “/” denotes a line break); this required enlarging the allocated area at the expense of adjacent labels. Some embodiments allowed the virtual image labels to expand beyond the extent of the keyboard itself; this was particularly useful for expanding descriptions of function keys located along the top row of the keyboard.

Some embodiments created the perception that a key's virtual image label also moved down when the key was pressed. This was done by shifting the hue of the virtual image label from a longer wavelength to a shorter one. The best results were obtained when both hues were pure colors, such as red and blue. The term “pure color” is being used herein to denote the hues depicted by the sub-pixel elements of a particular screen, typically red, green, and blue. The term “highly saturated” will be used herein to denote a color where most of the intensity comes from a single pure color, and less than ⅕ of the intensity comes from any other color. Even though the screen was planar, the color shift created the visual perception that the key had moved “downwards”, that is, into the plane of the keyboard. This effect was especially pronounced when the default virtual image label was red surrounded by a black border in a generally red background, and the virtual image label changed to blue when the key was pressed. The effect was enhanced when the location of the newly blue virtual image label moved within the plane of the keyboard to match the apparent (pressed) position of the key; for a an apparent change in key height h observed at an angle g, measured from a perpendicular line to the plane of the keyboard, the resulting lateral displacement equals h*tan(g).

Each application can provide a customized set of maps associating the various control key combinations with their resulting functions. The application can provide text for the labels, and the virtual image software can create the associated images, so other applications need not provide hardware-specific image files.

Opening an application can open a new instance of the virtual image labeling software in a separate window displayed on the screen. While that application is running, the associated instance of the virtual image labeling software can remain the top window displayed by the screen, and react to holding one or more control keys by changing the display on the screen, thereby changing the virtual image labels of the keyboard. When the focus changes to a second application, the instance of the virtual image label software associated with the second application becomes the new top window on the screen. This simplifies the interface between each application and the virtual image label software while allowing application-specific virtual image labels.

In some embodiments, the more frequently used shortcuts were highlighted. For example, in some embodiments, pressing <Ctrl> caused all the enabled shortcuts to be displayed, but only the “Cut”, “Copy”, “Paste”, “Select all”, and “Save” shortcuts were highlighted. In some embodiments, the least frequently used shortcuts were omitted from the virtual image labeling, to simplify the choices displayed. Which shortcuts should be highlighted and which (if any) should be omitted can be chosen on an application-by-application basis, or by tracking the frequency of use for each shortcut and/or function and adapting the virtual image labeling accordingly.

Creating a user profile and tracking the frequency of shortcuts used within a particular application can allow the system to adapt to the that user. The term “statistic” shall be used herein to denote a particular number statistically related to a particular key or key combination. For example, an exponentially weighted moving average (EWMA) is a statistic that allows efficient tracking of a series of data points. The term “profile” shall be used herein to denote a set of statistics. With an EWMA, each new data point could have a weighting of 0.01 and the prior EWMA would thus have a weighting of 0.99; after the initialization period, this causes the weighting factor for each event to decrease exponentially as subsequent events occur. To store the usage frequency of the combination of <Ctrl> and “C” (denoted “̂C”) with a weighting factor of 0.01, every time that combination was used the new EWMA for AC would be set to

EWMÂC(new)=0.99×EWMA(old)+0.01×MAX,

but every time <Ctrl> was used in combination with any other key (but not another control key), the new EWMA for AC would be set to

EWMÂC(new)=0.99×EWMA(old),

where “MAX” denotes the largest storable value, and non-occurrence is defined as zero; the value of 0.01×MAX remains constant, and need not be recalculated every cycle. For each combination, the running frequency, on a scale of 0 to 1, would thus be EWMA/MAX. A separate statistic is stored for every combination being tracked, but the precision of floating point numbers is not required. For a 16 bit unsigned integer, MAX=65,535, and the value of each statistic would range from 0 to 65,535. A user profile could consist of a statistic for each of the functions and shortcuts being tracked.

Where computational speed is at a premium, the weighting factors can be chosen so as to substitute a bit shift and subtraction for the multiplication. For example, if the weighting factor for each new point were set to 1/256 (rather than 1/100), the new EWMA for a negative result would be

EWMA(new)=(1− 1/256)×EWMA(old)=EWMA(old)−EWMA(old)/256

which can be accomplished by subtracting from EWMA(old) a eight bit shifted copy of itself.

If the system tracks the shortcuts activated by the user, the system can adapt the virtual image labels to display the shortcuts that the user actually invokes. However, if the system also tracks activation of the functions themselves, the system can adapt to what the user might like to do, by highlighting rarely used shortcuts to frequently used functions.

Multiple sets of exponentially weighted moving averages can be used to determine whether the circumstances of use have significantly changed. For example, three sets of weighting factors, 0.001/0.999, 0.01/0.99, and 0.1/0.9, could be use to track the long-term profile, medium-term profile, and short-term pattern. The long-term and medium-term profiles can then be checked against the short-term pattern, by calculating their dot products, to see which profile provides the best match to the current usage pattern. Using the short-term pattern to choose between displaying virtual image labels based on either the long-term or medium-term profile, rather than using a short-term profile, is intended to reduce the required frequency of changes to the shortcuts displayed for each control key or combination of control keys.

Compound virtual image labels, e.g., “Copy (̂C)”, can remind the user about particular shortcuts. For example, by tracking the average interval between holding down a control key and subsequently pressing a particular character key, in this case <Ctrl> and “C” respectively, the system can detect which shortcuts the user has difficulty remembering. The virtual image labels of these shortcuts can subsequently be highlighted or have a compound virtual image label, rendering them more memorable. If desired, these compound virtual image labels can be displayed even in the absence of control key actuation. Once user speed for a particular shortcut improves, the virtual image labeling of that shortcut can revert to the default. Compound or highlighted labels can also be displayed for rarely used shortcuts to frequently used functions, since such a situation implies that the user is relatively unfamiliar with that shortcut. The general term “distinguish” shall be defined as emphasizing a particular virtual image label or labels, such as by highlighting, underlining, or changing font.

The term “character set” shall include both an alphabet, such as Latin or Cyrillic, and a symbol set, such as mathematical functions. The phrase “changing character sets” explicitly excludes mere rearrangement.

I claim:

1. An apparatus comprising:
a computer comprising
a keyboard,
a screen with a display area, and
an angular articulation between the keyboard and the screen; and
a reflective plate between the keyboard and the screen,
whereby reflection of an inverted task displayed on the screen creates a right-reading virtual image visible to a user, thereby decreasing the physical space required to operate the computer.

2. The apparatus of claim 1,
wherein the keyboard and the screen are configured such that the virtual image remains readable by the user when a ratio of an operational size to the display area's height is less than 1.6.

3. A method of operating a laptop computer having a screen and a keyboard with a first input key, a second input key, a first control key, and a second control key, and a reflective surface at an angle between the keyboard and the screen, comprising the steps of:
providing, on the screen, an inverted image of a task, thereby creating a right-reading virtual image of the task;
providing, on the screen, an inverted image of a first input key default label, thereby creating a first right-reading virtual image default label at the first key; and
providing, on the screen, an inverted image of a second input key default label, thereby creating a second right-reading virtual image default label at the second key.

4. The method of claim 3, further comprising the step of:
detecting a user request for a change of character set; and
changing character sets by
(1) replacing the inverted image of the first input key default label with an inverted image of a first input key replacement character; and
(2) replacing the inverted image of the second input key default label with an inverted image of a second key replacement character,
thereby changing the character set appearing within the right-reading virtual image labels at the first and second keys.

5. The method of claim 3, further comprising the steps of:
determining the status of the first control key;
determining the status of the second control key;
detecting that the first control key but not the second control key was being actuated; and
in response to detecting that the first control key but not the second control key was being actuated,
(1) changing the inverted image of the first input key label to indicate a first character that would be generated by pressing the first input key in conjunction with only the first control key; and
(2) changing the inverted image of the second input key label to indicate a second character that would be generated by pressing the second input key in conjunction with only the first control key.

6. The method of claim 3, further comprising the steps of:
determining the status of the first control key;
determining the status of the second control key;
detecting that the second control key but not the first control key was being actuated; and
in response to detecting that the second control key but not the first control key was being actuated,
(1) changing the inverted image of the first input key label to indicate a first function that would be activated by pressing the first input key in conjunction with only the second control key, and
(2) changing the inverted image of the second input key label to indicate a second function, different from the first function, that would be activated by pressing the second input key in conjunction with only the second control key.

7. The method of claim 6, further comprising the steps of:
determining the status of the first control key;
determining the status of the second control key;
detecting that the both the first and second control keys were being actuated; and
in response to detecting that the both the first and second control keys were being actuated,
(1) changing the inverted image of the first input key label to indicate a third function, different from the first function, that would be activated by pressing the first input key in conjunction with both the first and second control keys, and
(2) changing the inverted image of the second input key label to indicate a fourth function, different from the second function, that would be activated by pressing the second input key in conjunction with both the first and second control keys.

8. A method of operating a laptop computer having a screen and a keyboard with a first input key, a second input key, a first control key, and a second control key, and a reflective surface at an angle between the keyboard and the screen, comprising the steps of:
providing on the screen an inverted image of a first area of a task, positioned such that reflection of the first area by the reflective surface creates a right-reading virtual image of the first area extending over both the first and second input keys; and
providing on the screen an inverted image of a second area of the task, positioned such that reflection of the second area by the reflective surface creates a right-reading virtual image of the second area that does not extend over the input keys.

9. The method of claim 8, wherein the task has an active portion, comprising the further step of automatically scrolling the task to preferentially locate the active portion within the second area.

10. The method of claim 8, further including the steps of:
determining the status of the first control key;
determining the status of the second control key;
detecting that at least one of the control keys was being actuated; and
in response to detecting that at least one of the control keys was being actuated,
(1) providing an inverted image of a first input key label, indicative of the result of pressing the first input key in conjunction with the detected control key(s), in a location previously within the inverted image of the first area of the task, and
(2) providing an inverted image of a second input key label, indicative of the result of pressing the second input key in conjunction with the detected control key(s), in a location previously within the inverted image of the first area of the task,
thereby creating a first virtual image label at the first input key and a second virtual image label at the second input key indicative of the respective changes in functionality due to activation of the control key(s).

11. The method of claim 9 further including the steps of:
determining the status of the first control key;
determining the status of the second control key;
detecting that at least one of the control keys was being actuated; and
in response to detecting that at least one of the control keys was being actuated,
(1) providing an inverted image of a first input key label, indicative of the result of pressing the first input key in conjunction with the detected control key(s), in a location previously within the inverted image of the first area of the task, and
(2) providing an inverted image of a second input key label, indicative of the result of pressing the second input key in conjunction with the detected control key(s), in a location previously within the inverted image of the first area of the task,
thereby creating a first virtual image label at the first input key and a second virtual image label at the second input key indicative of the respective changes in functionality due to activation of the control key(s).

12. A computer-readable medium for use on a computer system, the computer-readable medium having computer-executable instructions for performing the method of claim 3.

13. A computer-readable medium for use on a computer system, the computer-readable medium having computer-executable instructions for performing the method of claim 4.

14. A computer-readable medium for use on a computer system, the computer-readable medium having computer-executable instructions for performing the method of claim 5.

15. A computer-readable medium for use on a computer system, the computer-readable medium having computer-executable instructions for performing the method of claim 6.

16. A computer-readable medium for use on a computer system, the computer-readable medium having computer-executable instructions for performing the method of claim 7.

17. A computer-readable medium for use on a computer system, the computer-readable medium having computer-executable instructions for performing the method of claim 8.

18. A computer-readable medium for use on a computer system, the computer-readable medium having computer-executable instructions for performing the method of claim 9.

19. A computer-readable medium for use on a computer system, the computer-readable medium having computer-executable instructions for performing the method of claim 10.

20. A computer-readable medium for use on a computer system, the computer-readable medium having computer-executable instructions for performing the method of claim 11.
